(19) United States
(12) Patent Application Publication
(10) Pub. No.: US 2006/0142941 A1
(43) Pub. Date: Jun. 29, 2006

(54) Car navigation device and car navigation method for three-dimensional display of route information

(75) Inventors: Kazushige Imai, Tokyo (JP); Isao Nomura, Tokyo (JP)

Correspondence Address: FOLEY AND LARDNER LLP;SUITE 500, 3000 K STREET NW, WASHINGTON, DC, 20007, US

(73) Assignees: PIONEER CORPORATION; PIONEER DESIGN CORPORATION

(21) Appl. No.: 11/297,631

(22) Filed: Dec. 9, 2005

(30) Foreign Application Priority Data
Dec. 10, 2004 (JP) 2004-358399
Dec. 10, 2004 (JP) 2004-358400
Dec. 10, 2004 (JP) 2004-358401

(51) Int. Cl. G01C 21/32; G01C 21/30; G01C 21/26; G01C 21/36; G01C 21/34; H04N 7/18

(52) U.S. Cl. 701/211; 701/200; 725/75

(57) ABSTRACT

An information display apparatus, which displays a road and a plurality of buildings along the road three-dimensionally on a display screen installed in a vehicle, includes: an output-level acquiring unit that acquires a current output level of an audio device installed in the vehicle; and an output-level displaying unit that displays the current output level of the audio device on one of the buildings that is displayed as if being farthest from a user in front of the display screen.

### BACKGROUND OF THE INVENTION

1. Field of the Invention

The present invention relates to a technology for displaying various types of information for route navigation on a vehicle effectively.

2. Description of the Related Art

Conventionally, variations of audio signals output by an audio output device were generally displayed using LEDs or other level meter provided on the audio output device. Furthermore, in-vehicle navigation systems are provided with display screens for displaying map information. There are cases where an in-vehicle audio device and an in-vehicle navigation system are respectively installed in a vehicle.

There are also in-vehicle navigation systems that are equipped with the functions of an in-vehicle audio device. Arts for making the display contents of these different devices be displayed on the same display screen have been disclosed (see, for example, Japanese Patent Application Laid-Open No. 2003-106862). With this art, the forms of objects, included in map information that are used for guiding a travel route of a vehicle, are displayed in a dynamically changing manner in linkage with an audio signal spectrum that is input.

Conventionally in traveling to a destination by a vehicle, a bearing to the destination with respect to a current position and directions in which to turn at major intersections can be made known by referencing a map. By using an in-vehicle navigation system having map information in advance, the destination can be arrived at by traveling according to a display of such bearings and directions of turning at intersections.

Conventionally, variations of speed and engine revolutions-per-minute (RPM) that are traveling states of a vehicle were generally displayed using an instrument panel of the vehicle. Furthermore, in-vehicle navigation systems are provided with display screens that display the current position at which a vehicle is traveling and a scheduled travel route using map information.

However, a display unit of the conventional in-vehicle audio device and the display screen of the in-vehicle navigation system are displayed at different display locations, making it troublesome to check the contents displayed. With the art disclosed in Japanese Published Unexamined Patent Application No. 2003-106862, since the forms of objects included in the map information are changed according to the spectrum of the input sound signals, the shapes of buildings and other actual objects at the current position of the vehicle change, preventing a passenger from finding the actual buildings that correspond to the buildings being displayed. That such changing of object forms for pursuing entertainment causes obstruction of the route guidance that the in-vehicle navigation system is to provide can be cited as an issue.

Furthermore, with the conventional art, a detailed map may not be available, for example, for regions in which roads are not furnished. In this case, better convenience will be provided by indicating the bearing to the destination instead of displaying the current position accurately. Especially during vehicle travel, instead of vaguely ascertaining the bearing to the destination by opening a map booklet, whether the current direction of travel is correct can be checked readily if the bearing to the destination can be displayed for guidance on a display screen, etc.

Even if an in-vehicle navigation system is used, unless detailed map information is provided, the directions of turning at intersections, etc., cannot be displayed accurately. Though an in-vehicle navigation system is an expensive system having detailed map information (data), a storage unit that stores the map information, various sensors that detect the current position and bearing of a vehicle, a computing unit for guiding the route to a destination, etc., it may not be possible to perform accurate route navigation and adequately put the inherent functions to use when traveling through regions without map information or regions with only map information of rough precision or when the map information are old.

When the route to a destination is a highway or is a single road without intersections, detailed route navigation itself may be unnecessary. For regions in which roads are not furnished, etc., an apparatus of simple arrangement that enables the general bearing to a destination to be known without the use of an in-vehicle navigation system is effective.

Furthermore, with the conventional art, the instrumental panel was limited in display area and did not enable display of various travel data. In-vehicle navigation systems were limited to displaying just map information. That various travel data besides the speed and engine RPM of a vehicle, such as information on traveling direction G, lateral G, etc., during travel of the vehicle cannot be displayed can thus be cited as an issue. Such G information are effective for providing improved entertainment in performing steering, braking, and other vehicle operations according to road curvatures or road types, such as mountain path, sloping road, etc., and effective display thereof was desired.

### SUMMARY OF THE INVENTION

It is an object of the present invention to at least solve the problems in the conventional technology.

An information display apparatus according to an aspect of the present invention displays a road and a plurality of buildings along the road three-dimensionally on a display screen installed in a vehicle, as if the buildings are moving toward a user in front of the display screen at a speed corresponding to an actual speed of the vehicle. The information display apparatus includes: an output-level acquiring unit that acquires a current output level of an audio device installed in the vehicle; and an output-level displaying unit that displays the current output level of the audio device on one of the buildings that is displayed as if being farthest from the user.

An information display apparatus according to another aspect of the present invention displays a road three-dimensionally on a display screen installed in a vehicle. The information display apparatus includes: a direction determining unit that determines a direction of a destination from a current position of the vehicle based on latitudes and longitudes of the destination and the current position; and a direction displaying unit that displays the direction on the display screen.

An information display apparatus according to still another aspect of the present invention displays information on a display screen installed in a vehicle. The information display apparatus includes: a first-gravity displaying unit that displays a first gravity that is currently applied to the vehicle on the display screen; and a second-gravity displaying unit that displays, when the vehicle has traveled a predetermined distance since the first gravity was displayed, a second gravity that is currently applied to the vehicle on the display screen.

A method according to still another aspect of the present invention is a method of displaying a road and a plurality of buildings along the road three-dimensionally on a display screen installed in a vehicle, as if the buildings are moving toward a user in front of the display screen at a speed corresponding to an actual speed of the vehicle. The method includes: acquiring a current output level of an audio device installed in the vehicle; and displaying the current output level of the audio device on one of the buildings that is displayed as if being farthest from the user.

A method according to still another aspect of the present invention is a method of displaying a road three-dimensionally on a display screen installed in a vehicle. The method includes: determining a direction of a destination from a current position of the vehicle based on latitudes and longitudes of the destination and the current position; and displaying the direction on the display screen.

A method according to still another aspect of the present invention is a method of displaying information on a display screen installed in a vehicle. The method includes: displaying a first gravity that is currently applied to the vehicle on the display screen; and displaying, when the vehicle has traveled a predetermined distance since the first gravity was displayed, a second gravity that is currently applied to the vehicle on the display screen.

The computer-readable recording medium according to still another aspect of the present invention stores a computer program that causes a computer to execute the above methods.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a functional configuration of an information display apparatus according to a first embodiment of the present invention;

FIG. 2 is a flowchart of a processing performed by the information display apparatus;

FIG. 3 is a block diagram of a hardware configuration of the information display apparatus;

FIGS. 4 and 5 are examples of a display screen displayed by the information display apparatus;

FIG. 6 is a schematic for illustrating an example of implementation of the information display apparatus;

FIG. 7 is a block diagram of a functional configuration of an information display apparatus according to a second embodiment of the present invention;

FIG. 8 is a flowchart of a processing performed by the information display apparatus;

FIGS. 9, 10 and 11 are examples of a display screen displayed by the information display apparatus;

FIG. 12 is a block diagram of a functional configuration of an information display apparatus according to a third embodiment of the present invention;

FIG. 13 is a flowchart of a processing performed by the information display apparatus; and

FIGS. 14 and 15 are examples of a display screen displayed by the information display apparatus.

### DETAILED DESCRIPTION OF THE PREFERRED EMBODIMENTS

Exemplary embodiments of the present invention are explained in detail below with reference to the accompanying drawings.

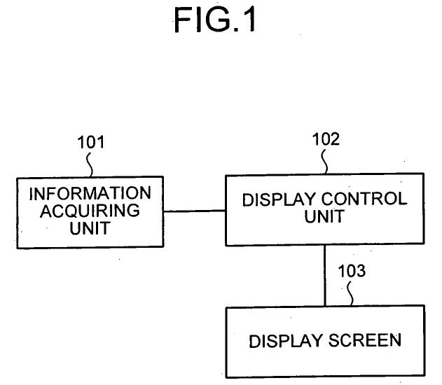

FIG. 1 is a block diagram of a functional configuration of an information display apparatus according to a first embodiment of the present invention. The information display apparatus shown in FIG. 1 is provided in a vehicle, such as a four wheel car and a motorcycle, and includes an information acquiring unit 101, a display control unit 102, and a display screen 103.

The information acquiring unit 101 acquires output levels of audio output information (hereinafter, also referred to as “audio signals”) that are output by an audio output device. The audio output device is, for example, an in-vehicle audio device that is mounted on the vehicle, an audio device such as a portable CD player, and other receiving device such as a radio and television that receives airwaves. The output level is, for example, the volume level. The information acquiring unit 101 also acquires at least one of speed information and engine RPM information of the vehicle. The information acquiring unit 101 also acquires at least one of inclination angle information and lateral G information of the vehicle.

Besides the information described above, the information acquiring unit 101 may acquire information on a state of the vehicle, for example, acceleration information, angular-velocity information, voltage information, direction information, time information, latitude and longitude information, torque information, and horse power information.

Furthermore, the information acquiring unit 101 may be arranged to acquire current position information of the vehicle and map information corresponding to the current position information. For the current position information and the map information, the functions of an in-vehicle navigation system that performs route guidance of a road to a destination may be used. The map information includes such information as road tracks, and the lot area, shape, and height (number of floors) of buildings, for each latitude and longitude.

Based on the map information, the display control unit 102 may display information concerning buildings along a road that is being traveled on, and, for example, may read information, such as the shapes of buildings, etc., at the current position of a traveling vehicle, from the map information and display these buildings three-dimensionally.

The display control unit 102 controls a single display screen 103 to display a road and roadside zones of the road to be seen three-dimensionally. Furthermore, based on speed information and engine RPM information of the vehicle, the display control unit 102 displays the speed and the engine RPM numerically.

The display control unit 102 controls the display screen 103 to display a road to be seen three-dimensionally. The display control unit 102 may display the road such that the display is changed dynamically according to lateral G based on lateral gravitational information of the vehicle. Specifically, for example, when lateral G is caused on the left side of the vehicle, the display control unit 102 judges that the vehicle is turning to the right and displays the road to curve to the right. Conversely, when lateral G is caused on the right side of the vehicle, the display control unit 102 judges that the vehicle is turning to the left and displays the road to curve to the left. Then, the display control unit 102 determines left and right direction amounts according to an amount of lateral gravity. Therefore, when lateral G is caused neither on the left nor on the right, the display control unit 102 judges that the vehicle is moving straight forward and displays the road to extend in the forward direction (curves neither to the left nor to the right).

The display control unit 102 displays an image, which shows a vehicle on a road, on the display screen 103. In addition, the display control unit 102 displays a background shown beside the road, which is displayed on the display screen 103, as if the background flows. In other words, the display control unit 102 displays a building to appear from the forward side of the road, move to the nearer side along the road, and disappear when the building moves to a side closest to a driver. This makes it possible to show the vehicle displayed on the display screen 103 as if the vehicle is traveling on the road.

The information acquiring unit 101 acquires speed information of the vehicle and the display control unit 102 changes speed for moving the background based on the speed information acquired by the information acquiring unit 101. This makes it possible, for example, to stop the movement of the background when the vehicle stops and increase moving speed of the background as the speed of the vehicle increases. As a result, the driver and the passenger can acquire a sense of speed through the display screen 103.

The display control unit 102 also displays output levels of audio signals acquired by the information acquiring unit 101 in a background displayed to a side of the road. Specifically, when the background is a building, an output level of an input audio signal is displayed by a bar in the height direction of the building. This bar is displayed so as to change according to the output level of the input audio signal, like an audio signal level meter.

A plurality of buildings, each of which bearing the bar indicative of the output level, are displayed to move according to the speed of the vehicle. As a result, the current output level is displayed on the building positioned furthest in the background, while past output levels are displayed on buildings that are moving towards the foreground.

Thus, according to the first embodiment, the moving speed of the vehicle and the output levels of the audio output information can be associated, and their changes can be also displayed dynamically, thereby providing improved entertainment.

The display screen 103 may be a dedicated display screen or may be a display screen of the in-vehicle navigation system. In the latter case, there is no need to mount the display screen 103 additionally on the vehicle. Furthermore, a passenger on a passenger seat can navigate easily because not only a driver but also the passenger can check a content of display easily.

Therefore, it is possible to improve entertainment using the in-vehicle navigation system even when a navigation function thereof is not used. In other words, the in-vehicle navigation system displays speed information and output levels of the audio output information simultaneously in stead of displaying map information for route navigation. This allows a driver and a passenger to enjoy a drive more.

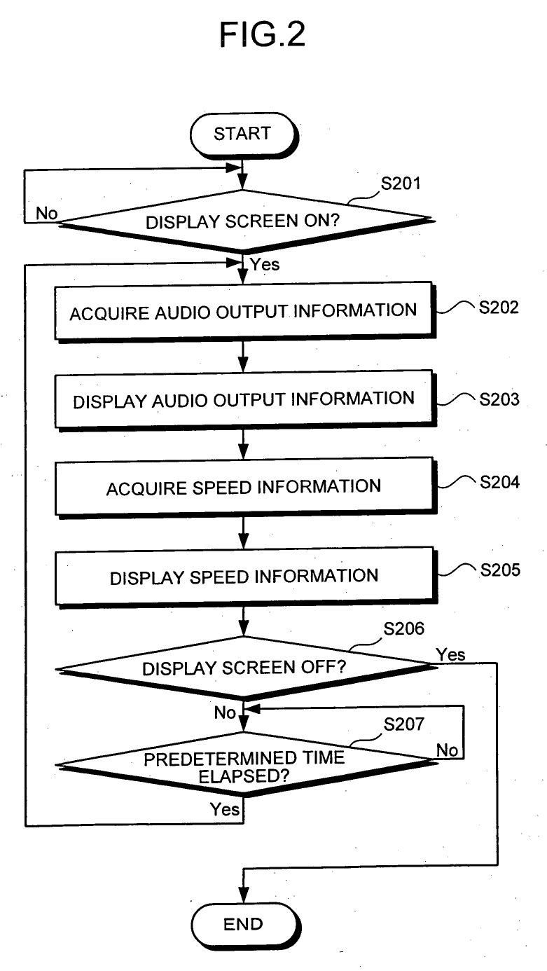

FIG. 2 is a flowchart of a processing performed by the information display apparatus according to the first embodiment. The information display apparatus judges whether the display screen 103 is ON (step S201). When the display screen 103 is ON (“Yes” at step S201), the information display apparatus acquires the audio output information (step S202) and displays the acquired audio output information in a predetermined area of the display screen 103 (step S203). In addition, the information display apparatus may acquire other information such as engine RPM information, inclination angle information, and lateral G information of the vehicle, and may display the acquired state information in a predetermined area of the display screen 103 according to a display method decided in advance.

The information display apparatus then acquires speed information (step S204) and displays the acquired speed information on the display screen 103 (step S205). Next, the information display apparatus judges whether the display screen 103 is turned OFF (step S206). If the display screen 103 is not turned OFF (“No” at step S206), the information display apparatus judges whether a predetermined time (e.g., several milliseconds) has elapsed (step S207). If the predetermined time has elapsed (“Yes” at step S207), the information display apparatus returns to step S202 and repeats the acquisition and display of speed information and state information.

Through such processing, the information display apparatus can display the audio output information and speed information, which change every moment, on the display screen 103. If the display screen 103 is turned OFF at step S206 (“Yes” at step S206), the information display apparatus ends the series of processing.

The audio output information displayed in step S203 and the speed information displayed in step S205 can be displayed to be seen three-dimensionally on a single display screen 103 using the road and buildings as described above.

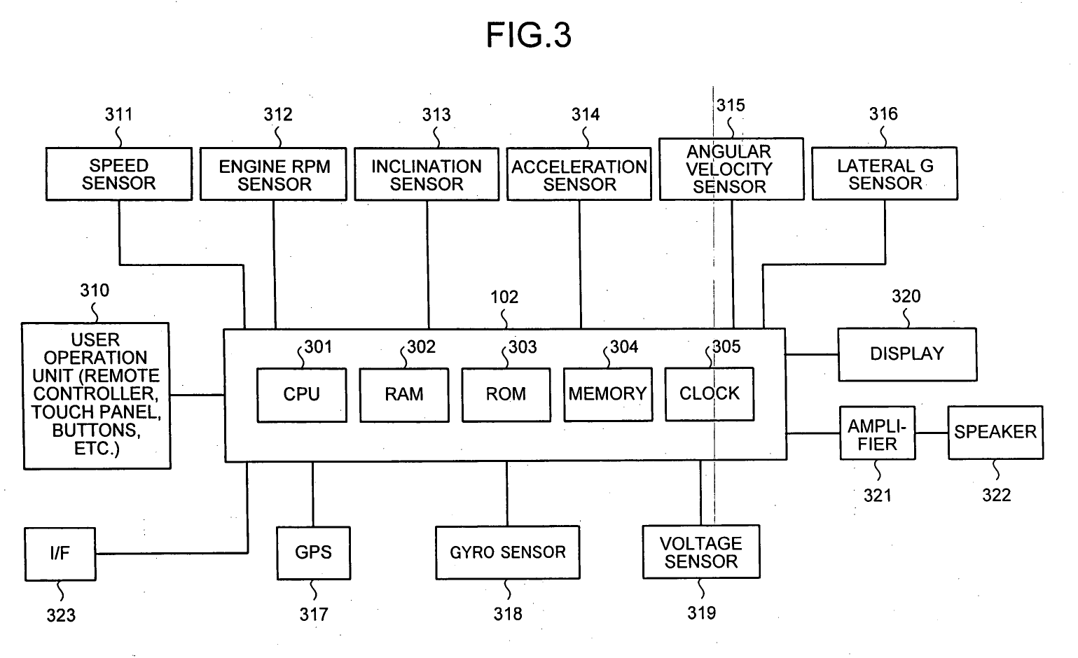

FIG. 3 is a block diagram of a hardware configuration of the information display apparatus according to the first embodiment. The information display apparatus includes a central processing unit (CPU) 301 functioning as the display control unit 102, a random access memory (RAM) 302, a read only memory (ROM) 303, a memory 304, and a clock 305. A user operation unit 310, a speed sensor 311 that detects speed of a traveling vehicle, an engine RPM sensor 312 that detects an engine RPM of the vehicle, an inclination sensor 313 that detects a inclination angle of the vehicle, an acceleration sensor 314 that detects acceleration of the vehicle, an angular velocity sensor 315 that detects angular velocity of the vehicle during cornering, and a lateral G sensor 316 that detects lateral gravity, that is an outward force (gravity) caused by a centrifugal force, are connected to the display control unit 102.

In addition, a global positioning system (GPS) 317 that detects a position (latitude and longitude information) of a vehicle by receiving radio waves from an artificial satellite, a gyro sensor 318 that detects a traveling direction of the vehicle, and the voltage sensor 319 for an electric system of the vehicle are connected to the display control unit 102. The sensors 311 to 319 realize the functions of the information acquiring unit 101. A display 320 functioning as the display screen 103, and an amplifier 321, are also connected to the display control unit 102.

The audio output information, output from an unillustrated audio output device, are input via an interface (I/F) 323. The audio output information that has been input via the interface 323 is amplified by the amplifier 321 and subject to audio output via speakers 322. The interface 323 can also perform wireless data communication with an external communication device.

The CPU 301 performs display control and also controls the entire information display apparatus. The RAM 302 is used as a work area of the CPU 301. The ROM 303 stores a basic processing program for the information display apparatus. The memory 304 stores various kinds of information. Specifically, for example, the memory 304 is a hard disk (HD). Alternatively, the memory 304 may be a detachable recording medium like a digital versatile disk (DVD) or a compact disk (CD). The clock 305 counts and stores information on the present time.

A function of the user operation unit 310 is realized by a touch panel, a remote controller, buttons provided in the information display apparatus, or the like. The display 320 can be, for example, a liquid crystal display or an organic electroluminescence (EL) display. The interface 323 performs data communication with a communication device on the outside by radio.

Although not shown in the figure, the information display apparatus may include a map database (DB), a navigation control unit, a position recognizing unit, a guide sound output unit, a point searching unit, a route acquiring unit, a route guiding-unit, and a guide sound generating unit that are provided in a general in-vehicle navigation system.

The navigation control unit informs the display 320 which location on a map a vehicle is traveling based on own vehicle location information calculated by the position recognizing unit and the map DB.

The guide sound output unit controls output to one or plural speakers 322 using the amplifier 321, thereby reproducing a guide sound.

The point searching unit searches for an arbitrary point based on information inputted from the user operation unit 310 and outputs the point to the display 320. The route acquiring unit calculates an optimum route to the point based on point information obtained by the point searching unit. The route guiding unit generates route guidance information on a real time basis based on information obtained by the route acquiring unit and the own vehicle location information.

The guide sound generating unit generates data of a tone and a sound corresponding to a pattern. In other words, the guide sound generating unit sets a virtual sound source corresponding to a guide point and generates sound guidance information based on route information and outputs the sound guidance information to the guide sound output unit.

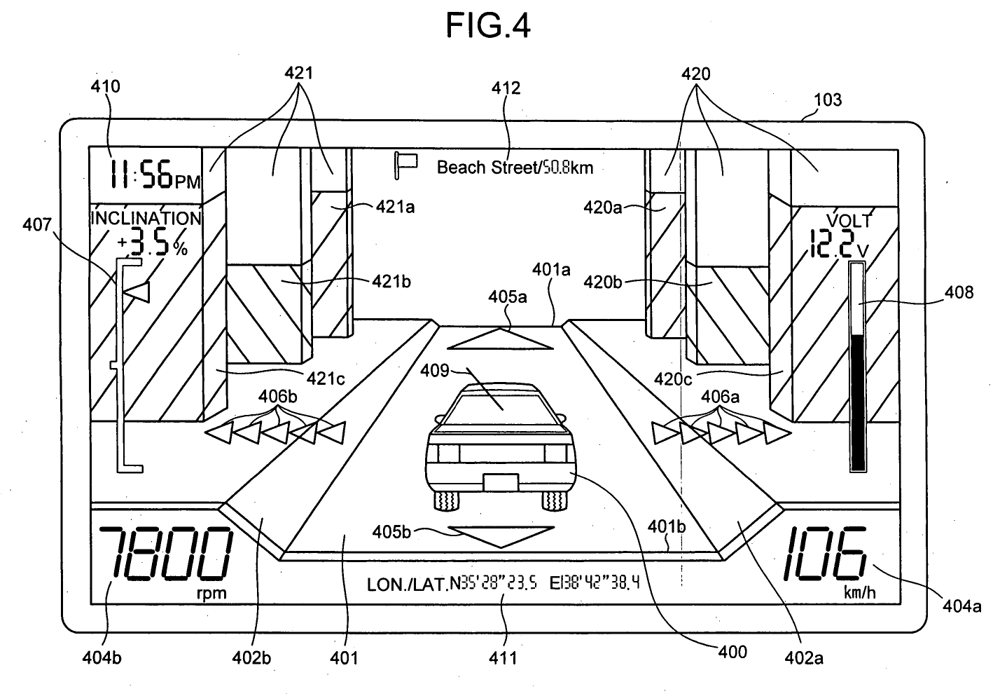

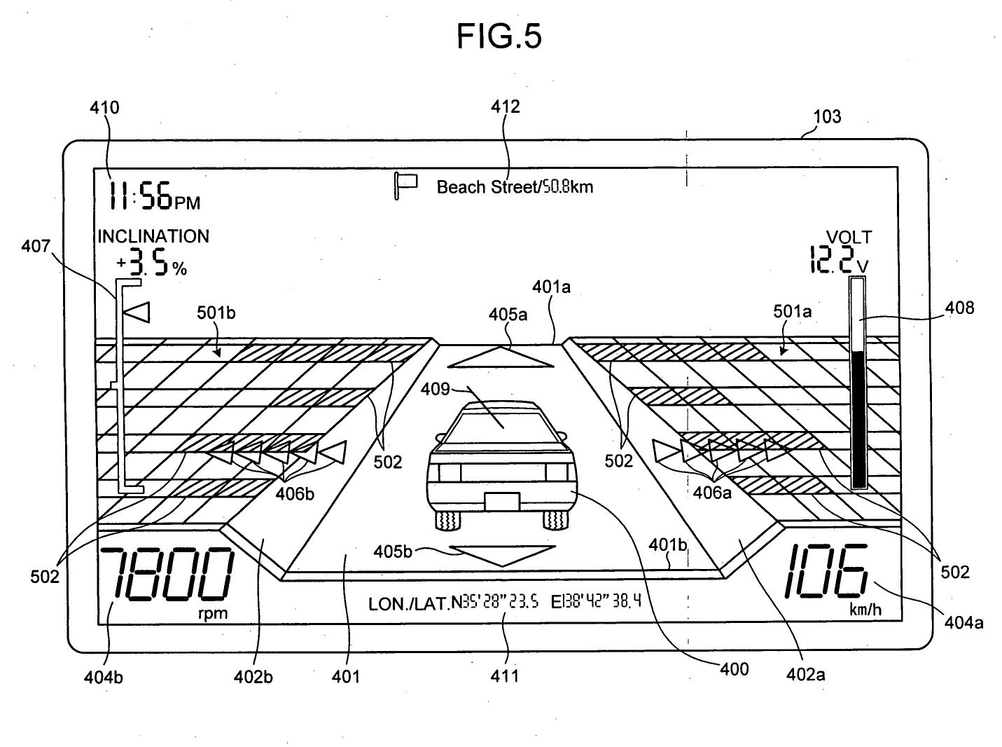

FIG. 4 and FIG. 5 are examples of the display screen displayed by the information display apparatus according to the first embodiment. In FIG. 4, reference numeral 400 on display screen 103 denotes a vehicle and 401 denotes a road displayed so as to appear to extend in the forward direction. The road 401 is displayed to be narrowed towards an upper portion of display screen 103 (farther end of road 401) so that its track takes on a three-dimensional appearance. Just the vehicle 400 can be made undisplayed by an operation of the driver or the passenger. In that case, scenery, modeled after actual scenery that the driver or the passenger can see from a windshield, may be displayed on the display screen 103.

A roadside zone 402a (on the right side) and a roadside zone 402b (on the left side), which have a predetermined angle, are displayed on the respective sides of the road 401. Plural buildings 420 are displayed on the right side of the roadside zone 402a and plural buildings 421 are displayed on the left side of the roadside zone 402b. The buildings 420 and 421 are displayed so as to appear to be moved from a forward side to a nearer side along the road 401. The buildings 420 and 421 may be imaginary buildings prepared in advance, or actual buildings, included in the map information, may be displayed as shall be described below.

Level bars 420a to 420c and 421a to 421c are displayed respectively on the buildings 420 and 421. The level bars 420a to 420c and 421a to 421c are displayed so as to vary in the height direction, from lower portions to upper portions of the buildings 420 and 421, according to the output levels (volume levels) of the audio output information (audio signals). The positions of the uppermost portions of the level bars 420a to 420c and 421a to 421c indicate the output levels. The buildings 420 and 421 are displayed using wireframe lines or displayed by a combination of surfaces such as polygons. The level bars 420a to 420c and 421a to 421c are displayed using predetermined colors inside buildings 420 and 421.

Reference sign 404a denotes a speed information display area (on the right side) provided by the roadside zone 402a having the predetermined angle. In FIG. 4, present speed “106 km/h” is displayed in a speed information display area 404a. Reference sign 404b denotes an engine-RPM-information display area (on the left side) provided by the roadside zone 402b having the predetermined angle. In FIG. 4, present engine RPM “7800 rpm” is displayed in the engine-RPM-information display area 404b.

The road 401 and the buildings 420 and 421 can be displayed so as to change in the speed of movement according to the speed of the vehicle 400. Specifically, the display is performed so that when the speed of the vehicle 400 is low, the speed of movement of the road 401 and the buildings 420 and 421 will be low and when the speed of the vehicle 400 is high, the speed of movement of the road 401 and the buildings 420 and 421 will be high.

Reference sign 405a denotes an acceleration information display mark on an acceleration side and 405b denotes an acceleration information display mark on a deceleration side. A color of one of the acceleration information display marks 405a and 405b changes. When a color of the acceleration information display mark 405a, which is displayed to be seen in front of the vehicle 400, changes, this indicates a state in which the vehicle 400 is accelerating. Conversely, when a color of the acceleration information display mark 405b, which is displayed to be seen in the rear of the vehicle 400, changes, this indicates a state in which the vehicle 400 is decelerating.

Reference numeral 406a denotes lateral G information display marks on the right side and 406b denotes lateral G information display marks on the left side. A color or the like of the lateral G information display marks 406a and 406b is changed according to an amount of lateral gravity. For example, when the lateral G is small, a color or the like of marks on the inner side is changed and, as the lateral G increases, a color or the like of marks on the outer side is changed. When the amount of the lateral G reaches a maximum amount set in advance, a color or the like of a mark on the outermost side is changed. Therefore, when the vehicle is moving straight forward and no lateral G is applied to the vehicle, a color or the like is not changed in all the marks.

Reference numeral 407 denotes an inclination-angle-information display area (INCLINATION), in which a level meter is displayed to indicate an amount of inclination at the present point. The amount of inclination may be displayed numerically near the level meter (‘+3.5%’ in FIG. 4). A way of showing inclination of the road 401 is also changed according to the amount of inclination. Specifically, the widths of a front end portion 401a and a base portion 401b are changed.

Reference numeral 408 denotes a voltage information display area (VOLT), in which a level meter is displayed to indicate a voltage at the present point. The VOLT 408 changes to an upper side as a voltage increases and changes to a lower side as a voltage decreases. A voltage is indicated by digital display together with analog display in the VOLT 408 (‘12.2 (V)’ in FIG. 4).

Reference numeral 409 denotes a destination direction information display bar. This destination direction information display bar 409 indicates a direction in which a set destination is present viewed from a present location. In FIG. 4, a destination is in a left forward direction with respect to a present traveling direction.

Reference numeral 410 denotes a time information display area. In FIG. 4, present time ‘11:56 (PM)’ is displayed in a digital form. Alternately, the time may be displayed in an analog form using an analog clock, or in 24-hour form.

Reference numeral 411 denotes a latitude and longitude information display area. In FIG. 4, the north latitude of a current position ‘N35′28″23.5’ and the east longitude of the current position ‘E138′42″38.4’ acquired from the GPS 317 are indicated by digital display.

Reference numeral 412 denotes a destination information display area. In FIG. 4, a location of a destination set in advance (‘Beach Street’) and a distance to the destination (‘50.8 km’) are indicated. A flag displayed at the left end is a mark for indicating that a displayed location is a destination. This mark is displayed to prevent ‘Beach Street’ from being recognized as a present location by mistake.

If the buildings 420 and 421 are displayed so as to be moved towards the nearer side along the road 401 according to the speed of the vehicle 400, the output levels that vary during the period, in which the buildings 420 and 421 are moved from the farther side to the nearer side and then erased, can be displayed on the buildings 420 and 421. The heights of the level bars 420a and 421a indicating the current output levels change according to the output levels, while the heights of the level bars 420b, 420c, 421b, and 421c on the buildings 420 and 421, which are moved towards the nearer side, are fixed throughout the movement as if a hold function is activated. By thus displaying the changing states of the output levels on the buildings 420 and 421, improved entertainment can be provided.

Alternatively, the current output levels may be displayed using level bars 420c and 421c on the nearest positioned buildings 420 and 421, and past output levels having a predetermined time interval may be displayed using the level bars 420b, 420a, 421b, and 421a on the buildings 420 and 421 that are positioned farther away.

Alternatively, the current output levels may be displayed using level bars 420c and 421c on the nearest positioned buildings 420 and 421, and future output levels may be displayed using the level bars 420b, 420a, 421b, and 421a on the buildings 420 and 421 that are positioned farther away. In this case, the information acquiring unit 101 (see FIG. 1) may be made to acquire music or other audio signals in advance to enable the future output levels to be displayed on the display screen 103.

Each of the level bars 420b, 420c, 421b, and 421c is, for example, displayed using the same predetermined color from the upper portion to the lower portion of the corresponding building 420 or 421, or may be displayed so as to be of a pale color at the lower portion side of the corresponding building 420 or 421 and become deeper in color towards the upper portion, or may be displayed in the manner of an audio level meter such that the color of a predetermined range from the lower portion to a predetermined height of the corresponding building 420 or 421 (for example, green) differs from the color of a predetermined range from the predetermined to height to the upper portion (for example, red).

If the acquired audio output information are left and right (stereo) audio signals that are independent of each other, the level bars 420a to 420c corresponding to the output levels of the right audio signals can be displayed on the buildings 420 at the right side of the road 401 and the level bars 421a to 421c corresponding to the output levels of the left audio signals can be displayed on the buildings 421 at the left side of the road 401.

The buildings 420 and 421 may be displayed so as to change in height according to the output levels of the audio output information. In this case, the heights of level bars 420a to 420c and 421a to 421c are displayed as the heights of the buildings 420 and 421.

In the above example, the output levels of the audio output information are volume levels. Alternatively, the output levels of the audio output information may be output levels for each frequency band. For example, output levels of the frequency band of low-pitched sounds may be displayed on the buildings 420 and 421 at the inner side of the display screen 103 and output levels of the frequency band of high-pitched sounds may be displayed on the buildings 420 and 421 at the nearer side. On the other hand, output levels of the frequency band of high-pitched sounds may be displayed on the buildings 420 and 421 at the inner side of the display screen 103 and output levels of the frequency band of low-pitched sounds may be displayed on the buildings 420 and 421 at the nearer side.

In the above example, the buildings 420 and 421 are imaginary buildings. Alternatively, the buildings 420 and 421 may be actual buildings acquired from the map information. With actual buildings, the buildings 420 and 421 displayed on the display screen 103 will frequently all differ in height and shape and especially will not be uniform in height. The maximum height positions of the level bars 420a to 420c and 421a to 421c may thus be set so as to vary within ranges up to predetermined heights. Furthermore, the maximum height positions of the level bars 420a to 420c may be made fixed regardless of the heights of the buildings 420 and 421 and displayed so as to exceed the uppermost portions of the buildings 420 and 421. Alternatively, average heights of the buildings 420 and 421 near the current position of the vehicle 400 may be determined based on information on the heights of the buildings 420 and 421 near the current position, and these average heights may be set as the maximum height positions of level bars 420a to 420c and 421a to 421c.

The buildings 420 and 421 displayed on the display screen 103 may not be fixed but may differ in the size in the direction along the road 401. In this case, for example, plural level bars 420a to 420c may be displayed on a single building 420 or a single level bar 420a may be displayed using the buildings 420.

Buildings 420 and 421 may not exist at the current position at which the vehicle 400 is actually traveling. In this case, the level bars 420a to 420c and 421a to 421c may be displayed in plural regions using background landforms and the boundary with the sky or the level bars 420a to 420c and 421a to 421c may be displayed in plural regions using boundaries with a river, farm field, etc.

FIG. 5 is a schematic diagram of a display example for a current position of the vehicle at which there are no buildings 420 and 421 and no clear boundaries. With the example shown in FIG. 5, the current position is a flat landscape and no buildings, etc., are displayed as background objects. In this case, since there is no information on buildings, etc., in the corresponding map information of the present location, nothing is displayed in a region 501a at the right side of the roadside zone 402a and in a region 501b at the left side of the roadside zone 402b.

Level bars 502 are displayed in these regions 501a and 501b. The level bars 502 are displayed in the form of changing in length in the left/right directions from the roadside zones 402a and 402b of the road 401 according to the output levels of the audio output information. Plural level bars 502 are displayed from the farther side to the nearer side of the road 401. As with the various display examples using the buildings 420 and 421, various types of display, such as displaying the current output levels at the farther side of the road 401 while displaying the past output levels at the nearer-side and performing stereo display, may be performed with the level bars 502.

By performing display using the map information, the road 401 and the buildings 420 and 421 at the current position of the vehicle 400 can be displayed on the display screen 103 to be seen three-dimensionally, and the output levels of the audio output information can be displayed using the displayed buildings 420 and 421. Since the map information and the audio output information, which ate information that inherently differ in display forms, are displayed not respectively in different regions but can be displayed using a single screen effectively and without complication, the entirety of the display screen 103 can be used effectively.

Furthermore, in using the map information to display the road 401 and the buildings 420 and 421, etc., that are background objects, by displaying the buildings 420 and 421 in their own actual shapes (for example, in regard to height, width, length, etc.), buildings that are necessary as guidelines for a passenger to check the current position during route navigation can be displayed on the display screen 103. The passenger is enabled to readily find the actual buildings outside the vehicle 400 according to their shapes while viewing the display on the display screen 103. Displays that provide both entertainment and practicality can thus be performed.

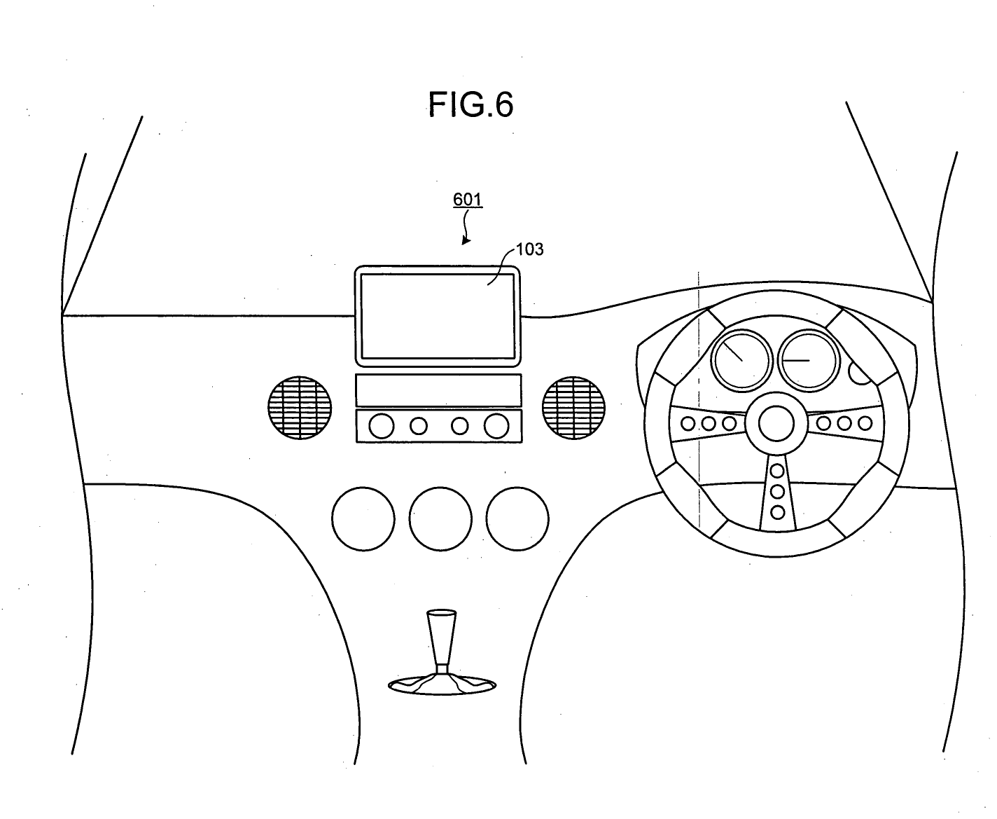

FIG. 6 is a schematic for illustrating an example of implementation of the information display apparatus according to the first embodiment. As shown in FIG. 6, an in-vehicle navigation system 601 is mounted between a driver seat and a passenger seat in a vehicle. A display of the in-vehicle navigation system 601 may be a display of an on-dashboard system or an in-dashboard system.

The display screen 103 may be a display screen of the in-vehicle navigation system 601. No additional display screen is required to be mounted on a vehicle, as long as the vehicle is provided with the in-vehicle navigation system 601 with a display screen that can be used as the display screen 103. By using the in-vehicle navigation system 601, a passenger on a passenger seat can navigate easily because not only a driver but also the passenger can check a content of display easily. Thus, using the in-vehicle navigation system 601, improved entertainment can be provided when the navigation function is not used.

As described above, according to the first embodiment, since a three-dimensional display that is according to the traveling state of the vehicle can be performed and this three-dimensional display can be used to display the audio output information simultaneously on the display screen 103, display contents that differ in form can all be checked readily and without complication. Furthermore, improved entertainment can be provided using the display screen 103 during travel. When the navigation function is used, since the map information can be used to display the shapes, etc., of buildings without breaking down the actual structural conditions and the audio output information can be displayed simultaneously using the displayed buildings, both practicality and entertainment can be provided at the same time. Furthermore, by displaying the buildings so as to move according to the travel conditions of the vehicle and performing display wherein the time of movement of the buildings and the changes with time of the audio output information are associated, the changing conditions of the output levels of music being issued, etc., can be displayed in a form of being synchronized with the changes with time and the entertainment can thus be improved further.

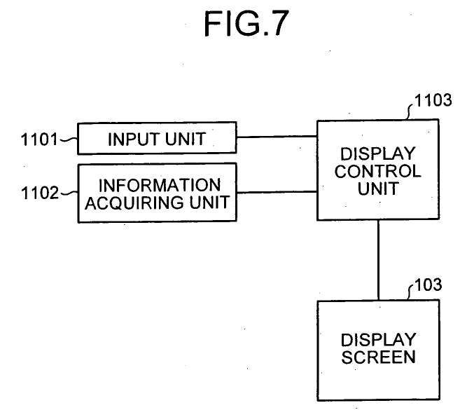

FIG. 7 is a block diagram of a functional configuration of an information display apparatus according to a second embodiment of the present invention. The information display apparatus shown in FIG. 7 is provided in a vehicle, such as a four-wheel car and motorcycle, and includes an input unit 1101, an information acquiring unit 1102, a display control unit 1103, and the display screen 103.

The input unit 1101 receives the input of latitude and longitude information of a destination and outputs the input latitude and longitude information to the display control unit 1103. The latitude and longitude information can be obtained by a user performing an operation of inputting the latitude and the longitude of the destination to which the vehicle is to travel. The information acquiring unit 1102 acquires latitude and longitude information of the current position and information concerning the traveling direction of the vehicle. The information acquiring unit 1102 may also acquire direction information indicating the current traveling direction of the vehicle.

The display control unit 1103 controls the display screen 103 to display a road to be seen three-dimensionally and display the direction to the destination based on the latitude and longitude information of the destination, the latitude and longitude information of the current position, and the traveling direction information. Since the direction to the destination can thus be displayed during travel, the direction in which the destination lies with respect to the traveling direction of the vehicle can be checked readily.

Specifically, based on the latitude and longitude and longitude information of the current position and the latitude information of the destination that are input by the input unit 1101, the display control unit 1103 displays, by an arrow, bearing information indicating the bearing to the destination with the current position as the reference.

The arrow used as the bearing information may be changed in length according to the distance from the current position to the destination. For example, the length of the arrow may be displayed to be long when the distance from the current position to the destination is long, and oppositely, the length of the arrow may be displayed to be short when the distance from the current position to the destination is short. Furthermore, on the display screen 103, the latitude and longitude information of the current position and the destination may be displayed numerically.

The display control unit 1103 controls the display screen 103 to display the road to be seen three-dimensionally, make a vehicle be positioned on the three-dimensionally displayed road, and make the arrow indicating the bearing to the destination be displayed from the vehicle portion.

The display control unit 1103 can also perform renewing display of the bearing information to be displayed on the display screen 103 after the start of travel of the vehicle. In this process, the latitude and longitude information of the current position can be acquired by information acquiring unit 1102 at each predetermined time to renew the direction of the arrow that indicates the bearing to the destination. When the vehicle is traveling, the longitude and the latitude of the current position change with time.

When the arrow indicating the bearing to the destination is to be displayed renewingly during the travel of the vehicle, since the upper portion of the display screen 103 is generally in the traveling direction, the arrow indicating the bearing to the destination will be displayed as pointing in the upward direction (directly upward or incliningly upward) during a large portion of the period until arrival at the destination. Depending on the direction in which the road traveled on is laid, the traveling direction of the vehicle at the current position with respect to the destination may change temporarily. The direction of the arrow can be changed freely to point in any of all directions of upper, lower, left, and right on the display screen 103 according to the change of the traveling direction of the vehicle. However, when the arrow continuously points in a downward, leftward, or rightward direction (a direction besides an upward direction), it can be judged that the traveling direction of the vehicle is deviated with respect to the destination.

The display control unit 1103 may also make an image indicating the vehicle on the road be displayed on the display screen 103 and at the same time make the background displayed at the sides of the road displayed on the display screen 103 appear to flow from the forward side (upper side) to the nearer side (lower side). That is, a building, etc., is displayed so as to appear from the forward side of the road, this building is displayed so as to move to the nearer along the road, and the building is displayed so as to disappear when the building has moved to the nearest side. The vehicle displayed on the display screen 103 can thereby be made to appear to travel along the road.

The display screen 103 may be a dedicated display screen or may be a display screen of the in-vehicle navigation system that has been mounted on the vehicle. In the latter case, there is no need to mount the display screen 103 additionally on the vehicle. Furthermore, not only a driver but also a passenger on a passenger seat can check a content of display easily. Thus, the passenger can check the bearing towards the destination easily.

According to the second embodiment, since during travel to a destination, the bearing to the destination as viewed from the current position can be displayed, whether the vehicle is traveling towards the destination can be ascertained at once.

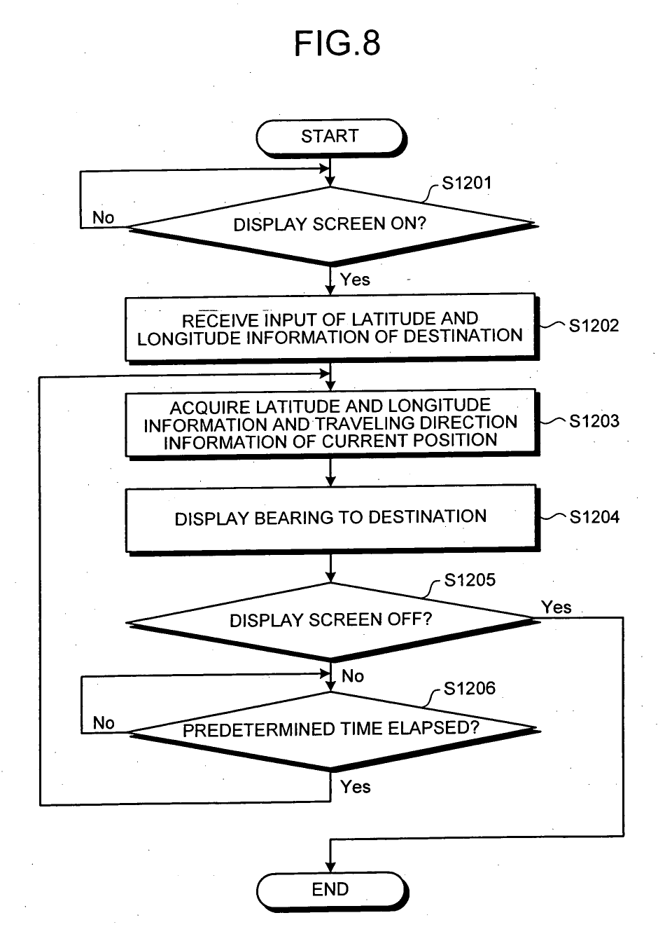

FIG. 8 is a flowchart of a processing performed by the information display apparatus according to the second embodiment of the present invention. The information display apparatus judges whether the display screen 103 is turned ON (step S1201). When the display screen 103 is turned ON (“Yes” at step S1201), the input of the latitude and longitude information of the destination is received (step S1202). The latitude and longitude indicated by the received latitude and longitude information of the destination may be displayed in a predetermined region of the display screen 103. The latitude and longitude information of the current position, the travel direction information of the vehicle, and other information are also acquired (step S1203). Then based on the latitude and longitude information of the destination, the latitude and longitude information of the current position, and traveling direction information, the bearing to the destination is displayed at a predetermined region of the display screen 103 using a predetermined display method (step S1204).

Next, the information display apparatus judges whether the display screen 103 is turned OFF (step S1205). If the display screen 103 is not turned OFF (“No” at step S1205), the information display apparatus judges whether a predetermined time (e.g., several milliseconds) has elapsed (step S1206). If the predetermined time has elapsed (“Yes” at step S1206), the information display apparatus returns to step S1203 and repeats the acquisition of the latitude and longitude information of the current position and display of the bearing towards the destination.

By this processing, the bearing to the destination that changes with time according to the travel of the vehicle can be displayed on the display screen 103. When the display screen is turned OFF (“Yes” at step S1205), the series of processing is ended.

The hardware configuration of the information display apparatus according to the second embodiment shall now be described using FIG. 3 that was shown for the first embodiment. The information display apparatus includes the CPU 301 functioning as the display control unit 102, the RAM 302, the ROM 303, the memory 304, and the clock 305. The user operation unit 310 that functions as the input unit 1101, the GPS 317 that functions as the information acquiring unit 1102 and detects the current position (latitude and longitude information) of the vehicle by receiving radio waves from artificial satellites, and the gyro sensor 318 that functions as the information acquiring unit 1102 and detects the traveling direction of the vehicle are connected to the display control unit 1103.

The functions of the information acquiring unit 1102 may also be realized by a speed sensor 311 that detects the speed of the traveling vehicle, the engine RPM sensor 312 that detects the engine RPM of the vehicle, the inclination sensor 313 that detects the inclination angle of the vehicle, the acceleration sensor 314 that detects the acceleration of the vehicle, the angular velocity sensor 315 that detects the angular velocity of the vehicle during cornering, the lateral G sensor 316 that detects the lateral gravities, that is, outward forces (gravities) caused by centrifugal forces, and a voltage sensor 319 for an electric system of the vehicle, and these respective sensors are also connected to the display control unit 1103.

The display 320 functioning as the display screen 103, and the amplifier 321, to which the speakers 322 are connected, are also connected to the display control unit 1103.

The CPU 301 performs display control and also controls the entire information display apparatus. The RAM 302 is used as a work area of the CPU 301. The ROM 303 stores a basic processing program for the information display apparatus. The memory 304 stores various kinds of information. Specifically, for example, the memory-304 is a hard disk (HD). Alternatively, the memory 304 may be a detachable recording medium like a digital versatile disk (DVD) or a compact disk (CD). The clock 305 counts and stores information on the present time.

A function of the user operation unit 310 is realized by a touch panel, a remote controller, buttons provided in the information display apparatus, or the like. The display 320 can be, for example, a liquid crystal display or an organic electroluminescence (EL) display. The interface 323 performs data communication with a communication device on the outside by radio.

According to the second embodiment, the latitude and longitude information of the destination that are input by the user operation unit 310, the latitude and longitude information of the current position of the vehicle that are detected by the GPS 317, and the traveling direction information of the vehicle that is detected by the gyro sensor 318 are input into the display control unit 1103. Then, based on the latitude and longitude information of the destination, the latitude and longitude information of the current position of the vehicle, and the traveling direction information of the vehicle, the CPU 301 that is provided in the display control unit 1103 performs display output of the bearing information that indicates the bearing to the destination on the display 320, that is, the display screen 103. As information displayed in this process, images of the road, background, vehicle, etc., can be displayed simulatedly in addition to the bearing information and the display output may be performed in a manner such that the background appears to flow.

The function of indicating the bearing to the destination can be realized using a function that is generally equipped by an in-vehicle navigation system. An in-vehicle navigation system generally has an arrangement that includes a display map DB, a navigation control unit, a position recognizing unit, a guidance sound output unit, a point searching unit, a route acquiring unit, a route guiding unit, and a guidance sound generating unit.

The navigation control unit informs the display 320 which location on a map a vehicle is traveling based on own vehicle location information calculated by the position recognizing unit and the map DB.

The guide sound output unit controls output to one or plural speakers 322 using the amplifier 321, thereby reproducing a guide sound.

The point searching unit searches for an arbitrary point based on information inputted from the user operation unit 310 and outputs the point to the display 320 to be displayed. The route acquiring unit calculates an optimum route to the point based on point information obtained by the point searching unit. The route guiding unit generates route guidance information on a real time basis based on information obtained by the route acquiring unit and the own vehicle location information.

The guidance sound generating unit performs setting of a virtual sound source and generation of audio guidance information according to guidance points for performing route guidance of intersections, etc., and outputs these to the guidance sound output unit.

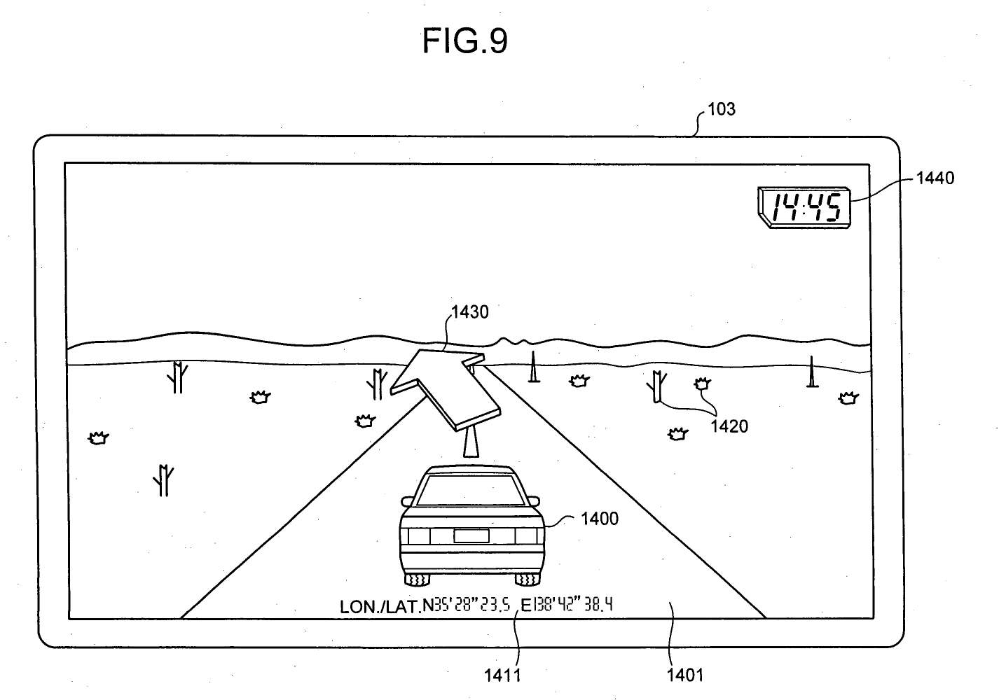

FIG. 9 is an example of a display screen displayed by the information display apparatus according to the second embodiment. In the display screen 103 shown in FIG. 9, reference numeral 1400 denotes a vehicle and 1401 denotes a road displayed so as to be seen as if the road extends in the forward direction. The road 1401 is displayed to be narrowed further in a forward portion thereof such that it looks as if the road 1401 extends in the forward direction.

The vehicle information of the display screen 103 is stored in the RAM 302 and the ROM 303, shown in FIG. 3. Just the vehicle 1400 can be made undisplayed by an operation of the driver or the passenger. In that case, scenery, modeled after actual scenery that the driver or the passenger can see from a windshield, may be displayed on the display screen 103.

Furthermore, a plurality of objects 1420 are displayed at the respective sides of the road 1401 and the road 1401 and the objects 1420 are displayed so as to appear to move from the forward side to the nearer side. The road 1401 and the objects 1420 may be displayed by changing the speed of movement according to the speed of the vehicle 1400. The objects 1420, shown in FIG. 9, are imaginary trees and plants that have been prepared in advance. Objects 1420 are not limited to being trees and plants and may be imaginary road signs, imaginary buildings, etc., instead.

Reference numeral 1411 denotes a latitude and longitude information display area for displaying the latitude and the longitude of the current position. In FIG. 9, the north latitude of the current position ‘N35′28″23.5’ and the east longitude of the current position ‘E138′42″38.4’ acquired from the GPS 317 shown in FIG. 3 are displayed in a digital form.

Bearing information 1430 with respect to the destination is displayed by an arrow on the road 1401. This bearing information 1430 indicates the direction of the destination as viewed from the current position of the vehicle 1400. In the example illustrated in FIG. 9, since the destination lies slightly to the left of the forward direction, the tip of the arrow is inclined slightly to the left.

The direction of the arrow that is the bearing information 1430 is arranged to change accordingly when the vehicle 1400 proceeds and the bearing to the destination changes. The bearing in which the destination lies with respect to the traveling direction of the vehicle 1400 can thereby be ascertained readily by the arrow indicated by the bearing information 1430.

Reference numeral 1440 denotes a time information display area. In FIG. 9, present time ‘14:45’ is indicated in a digital form. Alternately, the time may be displayed in an analog form using an analog clock, or in 12-hour form (AM/PM).

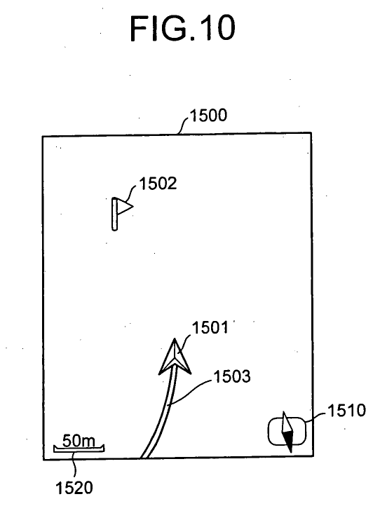

FIG. 10 is another example of the display screen. The display screen 1500 shown in FIG. 10 may be the display screen 103 or another display screen. The display contents shown in FIG. 9 and the display contents shown in FIG. 10 may be displayed simultaneously on the display screen 103.

FIG. 10 illustrates a planar display as viewed from above as in a map, with reference numeral 1501 denoting the vehicle and reference numeral 1502 denoting the destination. The vehicle 1501 indicating the current position and the destination 1502 are displayed based on latitude and longitude information.

The display control unit 1103 acquires latitude and longitude information based on the movement of the vehicle 1501. The acquired latitude and longitude information is accumulated in an HD or other memory 304. The latitude and longitude information of the past traveling of the vehicle can thus be accumulated as travel track information in the memory 304. As shown in FIG. 10, the display control unit 1103 displays a hypothetical road 1503 leading to the destination 1502 by joining each point, which is identified by the latitude and longitude information, where the vehicle has passed.

Reference numeral 1510, shown in FIG. 10, denotes a bearing information display region displaying the bearing of the destination. The vertical and horizontal sizes of the display screen 1500 are determined so that the vehicle 1501 and the destination 1502 will fit within the display screen. In FIG. 10, the bearing is displayed using a compass. Reference numeral 1520 denotes a scale. The scale 1520 is computed and displayed based on the latitude and longitude information of the vehicle's current position and the destination.

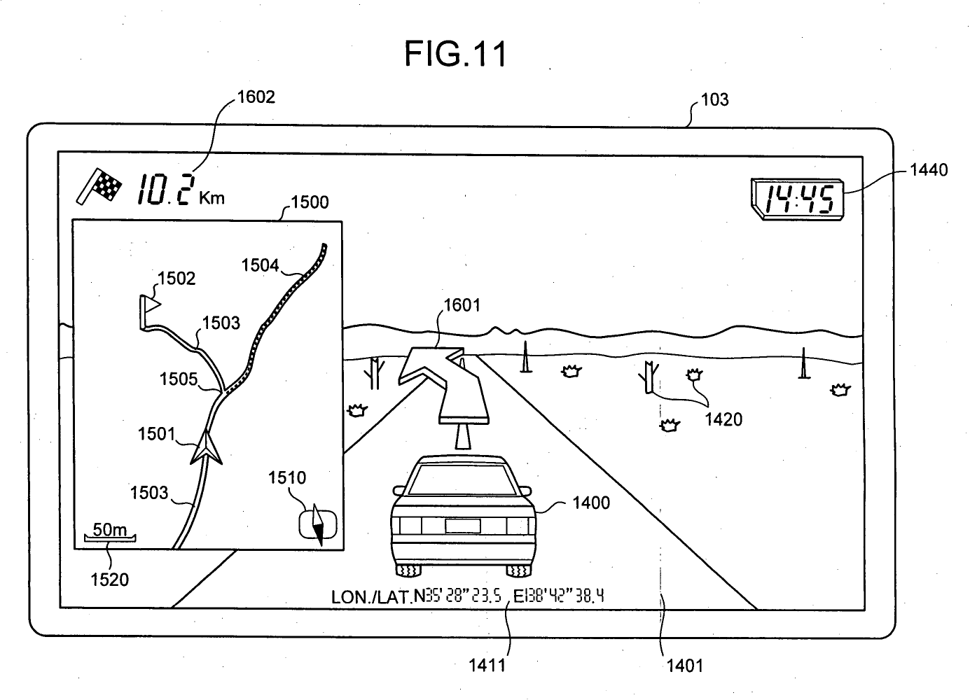

FIG. 11 is still another example of the display screen. FIG. 11 illustrates the display screen when the vehicle is traveling to a destination where the vehicle has been to before. The display screen 103 shown in FIG. 11 includes the display screen 1500 shown in FIG. 10.

If the vehicle has been to the destination 1502 before, the latitude and longitude information of the past travel of the vehicle are stored in memory 304. The virtual road 1503, on which the vehicle has traveled in the past, can thus be displayed in the display screen 1500. A road 1504 that is indicated by a dotted line is a road that does not lead to the destination 1502 but has been traveled on in the past. Though the road 1504 is indicated by a dotted line for convenience, it may be displayed with a solid line, a thick line, or double line like the road 1503.

By accumulating latitude and longitude information of past travels of the vehicle, it becomes possible to display the hypothetical roads 1503 and 1504. A fork 505 between the road 1503 to the destination 1502 and the road 1504 can also be displayed. An arrow 1601, which is the bearing information to the destination, is displayed in a bent state to provide the guidance that the vehicle should travel in a leftward inclining direction at the fork 505. The bend of the arrow 1601 indicates that the fork 505 exists. Thus, in the example shown in FIG. 11, the bearing information is displayed along the road 1503.

In addition to the latitude and longitude information of the past travel to the destination 1502, information on the distance to the destination 1502 may also be accumulated. The distance information is, for example, accumulated using the length of each road between a pair of forks 505 as a single interval distance. In traveling to the destination 1502 again, the remaining distance to the destination 1502 can thereby be displayed in a remaining distance display region 1602. The distance to the fork 505 may also be displayed.

An example of implementation of the information display apparatus according to the second embodiment shall now be described using FIG. 6 that was shown for the first embodiment. In the second embodiment, an information display apparatus 701 is mounted between a driver seat and a passenger seat in a vehicle. A display of the information display apparatus 701 may be a display of an on-dashboard system or an in-dashboard system. The display screen 103 may be a display screen of an in-vehicle navigation system (not shown).

Thus, with the second embodiment, the bearing of the destination with respect to the traveling direction of the vehicle can be displayed during travel to the destination without requiring map information. Thus, even if map information are not used or even in an area where map information are not furnished, the bearing to the destination can be ascertained readily.

By making the vehicle 1400, the road 1401, the accompanying background (objects 1420), etc., be displayed on the display screen 103, making a moving image be reproduced in the manner of a car game type computer game, and making the vehicle 1400 be displayed as if it is actually traveling or making map information (display screen 1500) be displayed in the manner of a role playing game type computer game, improved entertainment can be provided to a passenger or a driver in the vehicle during travel or while stopping.

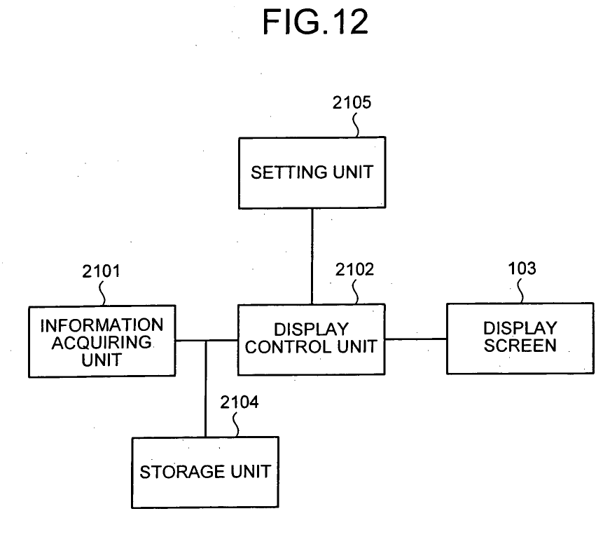

FIG. 12 is a block diagram of a functional configuration of an information display apparatus according to a third embodiment of the present invention. The information display apparatus shown in FIG. 12 is provided in a vehicle, such as a four wheel car and a motorcycle, and includes an information acquiring unit 2101, a display control unit 2102, the display screen 103, a storage unit 2104, and a setting unit 2105.

The information acquiring unit 2101 acquires speed information and engine RPM information of the vehicle as well as the vehicle's inclination angle information and lateral G information and traveling direction G information that are information on G's (gravities).

Besides the information described above, the information acquiring unit 2101 may acquire information on a state of the vehicle, for example, acceleration information, angular-velocity information, voltage information, direction information, time information, latitude and longitude information, torque information, and horse power information.

Furthermore, the information acquiring unit 2101 may be arranged to acquire current position information of the vehicle and map information corresponding to the current position information. For the current position information and the map information, the functions of an in-vehicle navigation system that performs route guidance of a road to a destination may be used. The map information includes such information as road tracks for each latitude and longitude.

The display control unit 2102 displays the travel direction G information and the lateral G information of the road on which the vehicle travels. These G information may be displayed not only during travel of the vehicle but also as information on the G's along a scheduled travel route when traveling again on a road that has been traveled on in the past. The G information during travel of the vehicle may be stored along with latitude and longitude information in the storage unit 2104 and read from the storage unit 2104 and displayed when traveling on the same road again. The traveling position and the scheduled travel route of the vehicle may be displayed using the map information.

Furthermore, during travel of the vehicle, the display control unit 2102 can renew and display the G information at the current position and the G information at passed past positions in a predetermined range. For example, a history display may be performed by renewing G information within a predetermined distance range based on the current position. In this case, the G information of the current position may be displayed constantly and the G information of positions that have been passed may be displayed in scrolling form.

The G information may be displayed using bar graphs that are according to the magnitudes of the G's. For the lateral G's, bars with lengths that extend in the left and right directions of the display screen 103 according to the magnitudes of the G's in the respective left and right directions of the vehicle are displayed. When the vehicle turns sharply to the right, a lateral G of magnitude corresponding to the curving motion is generated in the left direction, and when the vehicle turns sharply to the left, a lateral G of magnitude corresponding to the curving motion is generated in the right direction. When a lateral G is not generated in either of the left and right directions, the vehicle is proceeding straightly and the road lies in the forward direction (the steering wheel is not operated to the left or the right).

For the traveling direction G's, bars with lengths that extend in the upper and lower directions of the display screen 103 according to the magnitude of the G's in the respective forward and backward directions of the vehicle are displayed. When the vehicle accelerates, a backward G is generated and when the vehicle stops, a forward G is generated. The magnitude of the G becomes large in the case of sudden acceleration or sudden stoppage.

Thus, according to the third embodiment, the travel data of the vehicle can be displayed, thereby enabling the driving operation conditions of the vehicle to be displayed and the entertainment to be improved.

The display screen 103 may be a dedicated display screen or may be a display screen of the in-vehicle navigation system. In the latter case, there is no need to mount the display screen 103 additionally on the vehicle. Furthermore, a passenger on a passenger seat can navigate easily because not only a driver but also the passenger can check a content of display easily. Moreover, the driving conditions can be checked by the changes in the travel data, and navigation, wherein cautions concerning driving operations are provided to a driver, etc., can be performed.

The storage unit 2104 stores the information acquired by the information acquiring unit 2101. In the storage unit 2104 according to the third embodiment, the position information (latitude and longitude) of the travel of the vehicle are stored and the G information are stored as travel data according to the position information. The G conditions of the road on which the vehicle has traveled are thus stored in the form of a history.

The setting unit 2105 sets the scheduled travel route of the vehicle. When a destination is set in the in-vehicle navigation system, the in-vehicle navigation system computes a certain scheduled travel route from the current position to the destination. The computed scheduled travel route is set in the setting unit 2105. The set scheduled travel route is output to the display control unit 2102. When the scheduled travel route is set in the setting unit 2105, the display control unit 2102 reads the travel data (G information) corresponding to the scheduled travel route from the storage unit 2104. The G information that are the travel data along the scheduled travel route along which the vehicle is about to travel can thereby be displayed before travel or during travel.

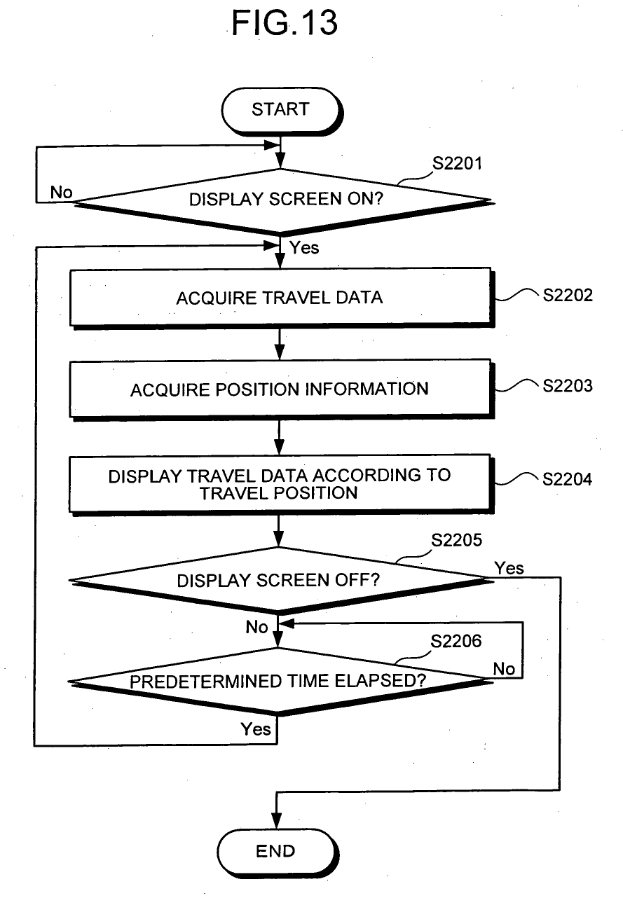

FIG. 13 is a flowchart of a processing performed by the information display apparatus according to the third embodiment of the present invention. The information display apparatus judges whether the display screen 103 is ON (step S2201). When the display screen 103 is ON (“Yes” at step S2201), the information display apparatus acquires travel data of a vehicle (step S2202) and displays the acquired travel data in a predetermined area of the display screen 103 (step S2203). The travel data are the information on G's (gravities).

In addition, the information display apparatus acquires position information on the current position of the vehicle (step S2203) and displays, for each of the acquired position, the acquired travel data in a predetermined area of the display screen 103 according to a display method decided in advance (step S2205). Next, the information display apparatus judges whether the display screen 103 is turned OFF (step S2206). If the display screen 103 is not turned OFF (“No” at step S2206), the information display apparatus judges whether a predetermined time (e.g., several milliseconds) has elapsed (step S2207). If the predetermined time has elapsed (“Yes” at step S2207), the information display apparatus returns to step S2202 and repeats the acquisition and display of the travel data and the position information.

Through such processing, the information display apparatus can display travel data (information on G's) on the display screen 103. If the display screen 103 is turned OFF at step S2205 (“Yes” at step S2205), the information display apparatus ends the series of processing.

The travel data displayed in step S2204 may be displayed as the G information according to travel positions and in the form of travel data history on the display screen 103.

The hardware configuration of the information display apparatus according to the third embodiment shall now be described using FIG. 3 that was shown for the first embodiment. The information display apparatus includes the CPU 301 functioning as the display control unit 2102, the RAM 302, the ROM 303, the memory 304, and the clock 305. The user operation unit 310, the speed sensor 311 that detects speed of a traveling vehicle, the engine RPM sensor 312 that detects an engine RPM of the vehicle, the inclination sensor 313 that detects an inclination angle of the vehicle, the acceleration sensor 314 that detects acceleration of the vehicle, the angular velocity sensor 315 that detects angular velocity of the vehicle during cornering, and the lateral G sensor 316 that detects lateral gravity, that is an outward force (gravity) caused by a centrifugal force, are connected to the display control unit 2102. The G sensor 316 detects the lateral G's that are outward forces that are generated by centrifugal forces during cornering and the traveling direction G's that are forward and backward forces that are generated in the process of acceleration and stoppage. The traveling direction G's can also be detected using the acceleration sensor 314.

In addition, the GPS 317 that detects a position (latitude and longitude information) of a vehicle by receiving radio waves from an artificial satellite, the gyro sensor 318 that detects a traveling direction of the vehicle, and the voltage sensor 319 for an electric system of the vehicle are connected to the display control unit 2102. The sensors 311 to 319 realize the functions of the information acquiring unit 101. The display 320 functioning as the display screen 103, and the amplifier 321 are also connected to the display control unit 2102.

Various information that are output from unillustrated external devices are input via the interface (I/F) 323. The interface 323 can also perform wireless data communication with external communication devices.

The CPU 301 performs display control and also controls the entire information display apparatus. The RAM 302 is used as a work area of the CPU 301. The ROM 303 stores a basic processing program for the information display apparatus. The memory 304 stores various kinds of information and constituting the storage unit 2104. Specifically, for example, the memory 304 is a hard disk (HD). Alternatively, the memory 304 may be a detachable recording medium like a digital versatile disk (DVD) or a compact disk (CD). The clock 305 counts and stores information on the present time.

A function of the user operation unit 310 is realized by a touch panel, a remote controller, buttons provided in the information display apparatus, or the like, to constitute the setting unit 2105. The display 320 can be, for example, a liquid crystal display or an organic electroluminescence (EL) display.

Although not shown in the figure, the information display apparatus may include a map database (DB), a navigation control unit, a position recognizing unit, a guide sound output unit, a point searching unit, a route acquiring unit, a route guiding unit, and a guide sound generating unit that are provided in a general in-vehicle navigation system.

The navigation control unit informs the display 320 which location on a map a vehicle is traveling based on own vehicle location information calculated by the position recognizing unit and the map DB.

The guide sound output unit controls output to one or plural speakers 322 using the amplifier 321, thereby reproducing a guide sound.

The point searching unit searches for an arbitrary point based on information inputted from the user operation unit 310 and outputs the point to the display 320. The route acquiring unit calculates an optimum route to the point based on point information obtained by the point searching unit. The route guiding unit generates route guidance information on a real time basis based on information obtained by the route acquiring unit and the own vehicle location information.

The guide sound generating unit generates data of a tone and a sound corresponding to a pattern. In other words, the guide sound generating unit sets a virtual sound source corresponding to a guide point and generates sound guidance information based on route information and outputs the sound guidance information to the guide sound output unit.

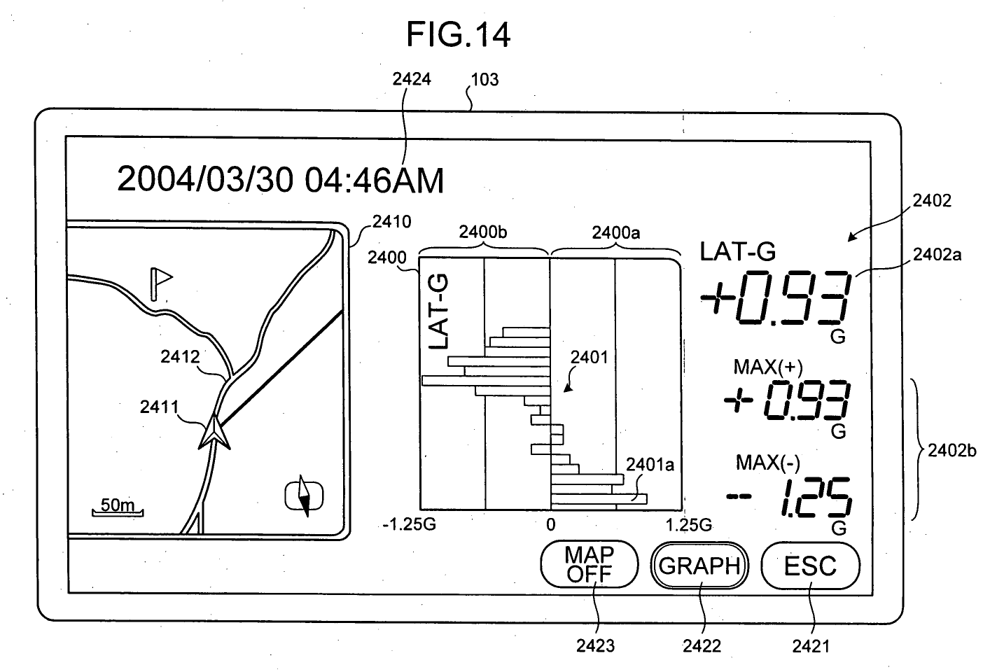

FIG. 14 is an example of a display screen displayed by the information display apparatus. A display area 2400 for the lateral G's that is the travel data is provided on the display screen 103. The central vertical axis corresponds to G=0, and a display region 2400a for lateral G's (positive) that are applied to the right side and a display region 2400b for lateral G's (negative) that are applied to the left side are provided. Level bars 2401 of lengths corresponding to the magnitudes of lateral G's are displayed so as to extend sideways (to the left and right).

The lateral G at the current position of the vehicle is displayed by the lowermost level bar 2401a. The level bars 2401 that are positioned above the lowermost level bar 2401a are those of past positions, and while the lowermost level bar 2401a is displayed constantly to indicate the lateral G of the current position, a history of the lateral G's for a predetermined distance (predetermined period) of the past is displayed. The level bar 2401a for the current position may be displayed using a color that differs from the display colors of the other level bars 2401. Furthermore, the uppermost level bar displayed in the lateral G display area 2400 may be displayed for the lateral G of the current position of the vehicle and the level bars 2401 positioned below the uppermost level bar may be displayed for the lateral G's of past positions.

A display area 2402 that displays lateral GIs numerically is provided at the side of the lateral G display area 2400. The display area 402 displays the current lateral G 2402a and the respective maximum values (MAX) 2402b of the right (positive) and left (negative) lateral G's of the past. Each of the values displayed in the area 2400 indicates the lateral G at each of the positions within a predetermined distance through which the vehicle has traveled.

A map information display area 2410 may be displayed at the side of the lateral G display area 2400. Reference numeral 2411 denotes the current position of the vehicle and reference numeral 2412 denotes a road. By thus displaying the travel position of the vehicle at the same time, the manner of curving of the road and the magnitude of the lateral G can be displayed in an associated manner.

Besides the above, a menu display key 2421, a display/undisplay changeover key 2422 for the lateral G display area 2400, and a display/undisplay changeover key 2423 for the map information display area 2410 are provided on the display screen 103. Reference numeral 2424 denotes a time information display region, wherein the current date and time of “2004 (year) 3 (month) 30 (day), 04:46 (AM)” are displayed in digital form. Alternately, the time may be displayed in an analog form using an analog clock, or in 24-hour form.

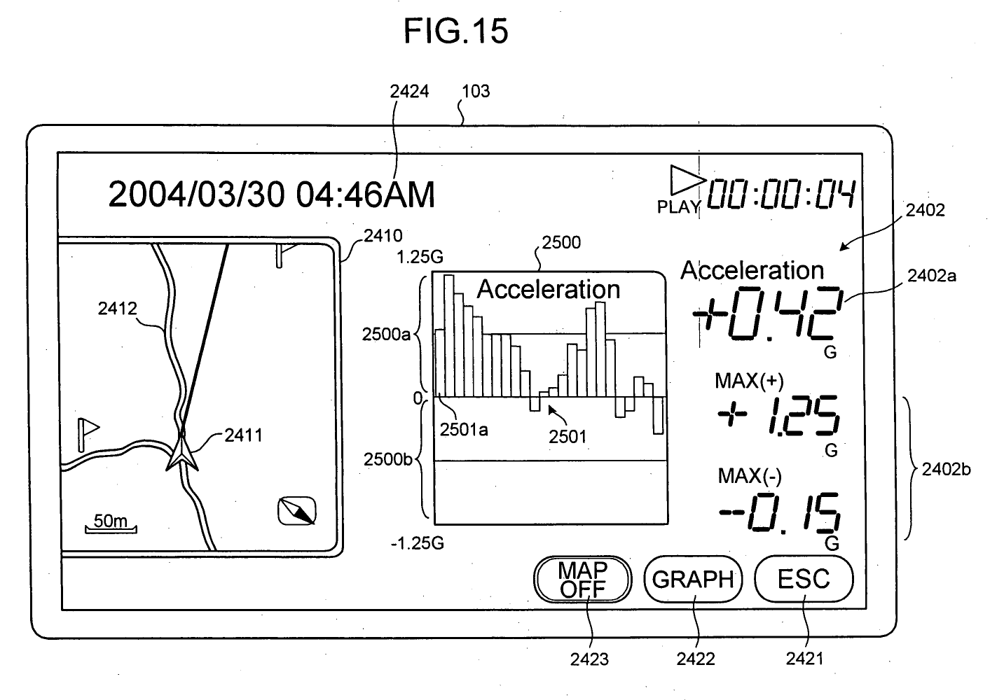

FIG. 15 is another example of the display screen. The Same contents that are shown in FIG. 14 are provided with the same reference numerals. In the display screen 103 shown in FIG. 15, a display area 2500 is provided for the traveling direction G's of the vehicle. The central horizontal axis corresponds to G=0, and a display region 2500a for traveling direction G's (positive) and a display region 2500b for traveling direction G's (negative) are provided. Level bars 2501 of lengths corresponding to the magnitudes of traveling direction. G's are displayed so as to extend in the upward and downward directions.

The traveling direction G at the current position of the vehicle is displayed by the leftmost level bar 2501a displayed in the traveling direction G display area 2500. The level bars 2501 that are positioned to the right of the leftmost level bar 2501a are those of past positions, and while the leftmost level bar 2501a is displayed constantly to indicate the traveling direction G of the current position, a history of the traveling direction G's for predetermined distance (predetermined period) of the past is displayed. The level bar 2501a for the current position may be displayed using a color that differs from the display colors of the other level bars 2501. Furthermore, the rightmost level bar displayed in the traveling direction G display area 2500 may be displayed for the traveling direction G of the current position of the vehicle and the level bars 2501 positioned to the left of the rightmost level bar may be displayed for the traveling direction G's of past positions.

A display area 2402 for displaying traveling direction G's numerically is provided at the side of the traveling direction G display area 2500. The display area 2402 includes the current traveling direction G 2402a and the maximum value (MAX) and minimum values 2402b of traveling direction G's of the past. Each of the values displayed in the area 2500 indicates the traveling direction G at each of the positions within a predetermined distance through which the vehicle has traveled.

As explained using FIG. 14 and FIG. 15, the lateral G's and the traveling direction G's displayed on the display screen 103 are displayed during the travel of the vehicle in the form of a history concerning the current position and the road in the past. The information acquiring unit 2101 (see FIG. 12) can store the position information and the G information during travel of the vehicle in an associated manner in the storage unit 2104. Thus, when a new scheduled travel route is computed by the in-vehicle navigation system, the G information along the scheduled travel route set in the setting unit 2105 can be displayed for a predetermined distance in advance prior to travel. Before the travel of the vehicle, the conditions of generation of lateral G's and travel direction G's according to such road conditions such as curving conditions and slopes can thus be checked to aid in inspection of various portions of the vehicle and encourage safe driving.

With an arrangement in which the G information is read from the storage unit 2104, the G information for the traveling direction (future) may be predicted and displayed constantly while the vehicle is traveling. For example, when the sizes of the lateral G level bars 2401 that are displayed in the lateral G display area 2400 (see FIG. 14) are large, it can be displayed in advance that there are many sharp turns. Furthermore, when the sizes of the traveling direction G level bars 2501 that are displayed in the traveling direction G display area 2400 (see FIG. 15) are large, it can be displayed in advance that there are many steep climbs or declines. The conditions of the road on which the vehicle is about to travel can thereby be ascertained to aid in the driving operation.

An example of implementation of the information display apparatus according to the third embodiment shall now be described using FIG. 6 that was shown for the first embodiment. Similar to the first embodiment, an in-vehicle navigation system 2601 is mounted between a driver seat and a passenger seat in a vehicle in the third embodiment. A display of the in-vehicle navigation system 2601 may be a display of an on-dashboard system or an in-dashboard system.

The display screen 103 may be a display screen of the in-vehicle navigation system 601. No additional display screen is required to be mounted on a vehicle, if the vehicle is provided with the in-vehicle navigation system 2601 with a display screen that can be used as the display screen 103. By using the in-vehicle navigation system 2601, a passenger on a passenger seat can navigate easily because not only a driver but also the passenger can check a content of display easily. By using such in-vehicle navigation system 2601, the travel data during driving can be displayed and the entertainment can be improved.

As described above, according to the third embodiment, by using level bars to display the G information as the travel data of the vehicle, it becomes possible to visually display the conditions of curves and slopes of the road on which the vehicle is traveling. Accordingly, it becomes possible to display the conditions of driving operations, such as the operations of the steering wheel, accelerator, and brakes. Furthermore, by storing the G information concerning roads that the vehicle has traveled on in the past, the driving operation conditions that are necessary for a road that is scheduled to be traveled on can be displayed in advance, thereby enabling a display that is effective for encouraging safe driving.

The information display method according to the present invention may be a computer readable program prepared in advance and is realized by executing the program with a computer like a personal computer or a workstation including a server. This program is recorded in a computer readable recording medium like a hard disk (HD), a floppy disk (FD), a compact disk ROM (CD-ROM), a magneto-optical disk (MO), or a digital versatile disk (DVD) and read out from the recording medium by the computer to be executed. This program may be recorded in a transmission medium deliverable via a network such as the Internet.

The present document incorporates by reference the entire contents of Japanese priority document, 2004-358399, 2004-358400 and 2004-358401, filed in Japan on Dec. 10, 2004.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An information display apparatus that displays a road and a plurality of buildings along the road three-dimensionally on a display screen installed in a vehicle, wherein the buildings are displayed as if moving toward a user in front of the display screen at a speed corresponding to an actual speed of the vehicle, the information display apparatus comprising:
an output-level acquiring unit that acquires a current output level of an audio device installed in the vehicle; and
an output-level displaying unit that displays the current output level of the audio device on one of the buildings that is displayed as if being farthest from the user.

2. The information display apparatus according to claim 1, wherein
the buildings includes a plurality of first buildings that are displayed on a first side of the road and a plurality of second buildings that are displayed on a second side of the road,
the output-level acquiring unit acquires a current output level of a first channel and a current output level of a second channel, and
the output-level displaying unit displays the current output level of the first channel on one of the first buildings that is displayed as if being farthest from the user, and displays the current output level of the second channel on one of the second buildings that is displayed as if being farthest from the user.

3. The information display apparatus according to claim 1, wherein display forms of the buildings are dynamically changed according to the output level displayed on the buildings.

4. The information display apparatus according to claim 1, wherein the information display apparatus displays a vehicle on the road.

5. The information display apparatus according to claim 1, wherein the information display apparatus displays the buildings based on a current position of the vehicle and a map information corresponding to the current position.

6. An information display apparatus that displays a road three-dimensionally on a display screen installed in a vehicle, the information display apparatus comprising:
a direction determining unit that determines a direction of a destination from a current position of the vehicle based on latitudes and longitudes of the destination and the current position; and
a direction displaying unit that displays the direction on the display screen.

7. The information display apparatus according to claim 6, further comprising
a route storing unit that stores a route on which the vehicle has traveled before, wherein
the direction displaying unit displays the direction along the route when the vehicle is traveling on the route again.

8. The information display apparatus according to claim 7, wherein the information display apparatus displays the route as well as the road.

9. The information display apparatus according to claim 6, wherein the information display apparatus displays a vehicle on the road.

10. An information display apparatus that displays information on a display screen installed in a vehicle, the information display apparatus comprising:
a first-gravity displaying unit that displays a first gravity that is currently applied to the vehicle on the display screen; and
a second-gravity displaying unit that displays, when the vehicle has traveled a predetermined distance since the first gravity was displayed, a second gravity that is currently applied to the vehicle on the display screen.

11. The information display apparatus according to claim 10, wherein
the first-gravity displaying unit displays the first gravity at a current-gravity area of the display screen,
the second-gravity displaying unit displays the second gravity at the current-gravity area in which the first gravity has been displayed, and
the first-gravity displaying unit redisplays the first gravity at a previous-gravity area that is adjacent to the current-gravity area.

12. The information display apparatus according to claim 10, wherein the first gravity and the second gravity are lateral gravities that are applied towards any one of a left direction and a right direction.

13. The information display apparatus according to claim 10, wherein the first gravity and the second gravity are traveling direction gravities that are applied any one of forwardly and backwardly with respect to a direction in which the vehicle is traveling.

14. The information display apparatus according to claim 10, wherein the information display apparatus displays a map for indicating a current position of the vehicle on the display screen.

15. The information display apparatus according to claim 10, further comprising:
a gravity storing unit that stores the first gravity and the second gravity as a history of gravity; and
a future-gravity displaying unit that displays, when the vehicle is traveling on a route on which the vehicle has traveled before, a future gravity that will be applied to the vehicle based on the history of gravity.

16. A method of displaying a road and a plurality of buildings along the road three-dimensionally on a display screen installed in a vehicle, wherein the buildings are displayed as if moving toward a user in front of the display screen at a speed corresponding to an actual speed of the vehicle, the method comprising:
acquiring a current output level of an audio device installed in the vehicle; and
displaying the current output level of the audio device on one of the buildings that is displayed as if being farthest from the user.

17. A method of displaying a road three-dimensionally on a display screen installed in a vehicle, the method comprising:
determining a direction of a destination from a current position of the vehicle based on latitudes and longitudes of the destination and the current position; and
displaying the direction on the display screen.

18. A method of displaying information on a display screen installed in a vehicle, the method comprising:
displaying a first gravity that is currently applied to the vehicle on the display screen; and
displaying, when the vehicle has traveled a predetermined distance since the first gravity was displayed, a second gravity that is currently applied to the vehicle on the display screen.

19. A computer-readable recording medium that stores a computer program for displaying a road and a plurality of buildings along the road three-dimensionally on a display screen installed in a vehicle, wherein the buildings are displayed as if moving toward a user in front of the display screen at a speed corresponding to an actual speed of the vehicle, and the computer program causes a computer to execute:
acquiring a current output level of an audio device installed in the vehicle; and
displaying the current output level of the audio device on one of the buildings that is displayed as if being farthest from the user.

20. A computer-readable recording medium that stores a computer program for displaying a road three-dimensionally on a display screen installed in a vehicle, wherein the computer program causes a computer to execute:
determining a direction of a destination from a current position of the vehicle based on latitudes and longitudes of the destination and the current position; and
displaying the direction on the display screen.

21. A computer-readable recording medium that stores a computer program for displaying information on a display screen installed in a vehicle, the computer program causes a computer to execute:
displaying a first gravity that is currently applied to the vehicle on the display screen; and
displaying, when the vehicle has traveled a predetermined distance since the first gravity was displayed, a second gravity that is currently applied to the vehicle on the display screen.
